(19) United States
(12) Patent Application Publication
(10) Pub. No.: US 2016/0357376 A1
(43) Pub. Date: Dec. 8, 2016

(54) OWNERSHIP-AGNOSTIC USER INTERFACE FOR MEDIA CONTENT

(71) Applicant: APPLE INC., Cupertino, CA (US)

(72) Inventors: Taylor G. Carrigan, San Francisco, CA (US); William Martin Bachman, San Jose, CA (US); Monika E. Gromek, Oakland, CA (US); Jeffrey L. Robbin, Los Altos, CA (US); Ofer Morag, Oakland, CA (US)

(73) Assignee: APPLE INC., Cupertino, CA (US)

(21) Appl. No.: 14/871,672

(22) Filed: Sep. 30, 2015

Related U.S. Application Data
(60) Provisional application No. 62/171,827, filed on Jun. 5, 2015.

(51) Int. Cl. G06F 3/0483; G06F 3/0484; G06F 3/0482; H04L 29/08; H04L 29/06

(52) U.S. Cl. CPC G06F 3/0483; H04L 67/20; H04L 67/306; H04L 65/60; H04L 67/42; G06F 3/0482; G06F 3/04842

(57) ABSTRACT

Listings of media content items can be presented on a user device in an ownership-agnostic matter. For instance, a user device can interact with both a streaming media service and a personal media collection, portions of which might or might not be hosted by the streaming media service. A listing of media content items that satisfy selection criteria can be presented in a page with multiple tabs. One tab can include a listing of all content items from the streaming music service that satisfy the criteria, regardless of whether the content items are associated with the user's personal collection. Another tab can include a listing of all content items in the user's personal collection that satisfy the criteria, regardless of whether the content items are in the catalog of the streaming music service.

### CROSS-REFERENCES TO RELATED APPLICATIONS

This application claims the benefit of U.S. Provisional Application No. 62/171,827, filed Jun. 5, 2015, entitled “Ownership-Agnostic User Interface for Media Content,” the disclosure of which is incorporated by reference herein in its entirety.

The present disclosure is related to U.S. Provisional Application No. 62/171,812, entitled “Social Interaction in a Media Streaming Service,” filed of even date herewith, the disclosure of which is incorporated herein by reference in its entirety.

### BACKGROUND

The present disclosure relates generally to media content management and in particular to an ownership-agnostic user interface for media content.

People love to consume media. With the advance of technology, a great deal of media content (including songs, albums, videos, books, etc.) is now available in digital form. By interacting with online services, consumers can purchase digital media content items, typically in the form of computer-readable data files containing a representation of media content that the consumers' electronic devices can use to render tangible outputs such as images and/or sounds (referred to as playing the content). More recently, the advent of broadband Internet connectivity has led to the development of “streaming” media services that can provide media content items to users' devices on a temporary basis, often in real time (i.e., the rate of data delivery to the user's device can keep up with the rate at which the user's device renders tangible outputs from the data). In general, a “streamed” media content item either is not stored on the user device or is stored only briefly, e.g., in a buffer, to support rendering operations on the user's device. This can allow users to consume media content without being limited by the storage capacity of their devices, often at lower cost than purchasing content items. Some streaming media services may also allow users to temporarily download media content items for offline consumption and/or to purchase media content items for long-term storage on the users' devices. Users can also augment their media collections with media content from other sources. For example, the user may purchase and “rip” an audio CD (compact disc). (“Ripping” refers generally to creating a digital media file in a compressed or compact format such as MP3, AAC, or the like, from audio data stored on a CD or other medium that is not in a compressed format or may not be digital at all.)

### SUMMARY

Through a combination of bookmarking, streaming, downloading, ripping, purchasing, and/or other activities, a user may create a personal collection of media content items. In some instances, some or all of the items in the user's personal collection need not be owned by the user (e.g., a content item that the user has bookmarked at a streaming media service or temporarily downloaded). This can make it challenging for the user to view the personal collection in anything like a holistic manner. For example, content items purchased or ripped by the user may be stored in a personal media library, e.g., on the user's device, that the user can access using a first application program (or “app”), while content items bookmarked or temporarily downloaded from a streaming media service may be accessible through a different app. In some instances, the same app may provide interfaces to both a personal media library and a streaming service, but locally-stored content may be accessible through a separate set of user interface screens from streaming content.

Certain embodiments of the present invention can provide more holistic access to media content. For instance, an application program executing on the user's device can facilitate interaction with both a personal media library and a streaming media service. When the user makes a request to view a listing of media content that satisfies a user-specified selection criteria, such as content by a particular artist, the listing can be organized to provide a holistic perspective. For instance, the listing can be presented by rendering a page view on the user's device, where the page has multiple tabs. One tab can include a listing of all content items from the catalog of the streaming music service that satisfy the criteria, regardless of whether the content items are associated with the user's personal media collection, and another tab can include a listing of all content items in the user's personal media collection that satisfy the criteria, regardless of whether the content items are in the catalog of the streaming music service and regardless of provenance (i.e., how the content items came to be included in the user's personal media collection). For instance, bookmarked content items, temporarily downloaded content items, and purchased content items can be presented in a combined listing, without segregation or other visual indicia based on provenance. The user can thus choose to view a listing of content items available from the catalog of the streaming media service (regardless of whether the content items are in the user's personal media collection) or to view a listing of content items in the user's personal media collection (regardless of how the content items got there or whether they are also available in the catalog of the streaming media service). The listings of media content items can be said to be “ownership-agnostic” in the sense that there is no need to segregate or visually indicate which content items in the listing are owned by the user and which are not.

In some embodiments, to facilitate generation of an ownership-agnostic listing, a streaming media service (or an app on the user's device) can define a “personal media profile” for a user. The personal media profile can include an entry for each content item in a catalog maintained by the streaming media service that the user has affirmatively indicated some sort of interest in, e.g., by bookmarking the item, temporarily downloading the item for offline consumption, or purchasing the item. The personal media profile can also include an entry for each content item stored in the user's personal music library, regardless of whether the content item is or is not in the catalog of the streaming media service and regardless of provenance (e.g., whether the content item was purchased from an online source, ripped from a CD, recorded by the user, etc.). In response to user requests for content items matching a selection criterion, a streaming media server (or an app on the user's device) can search the catalog of the streaming media service to generate a first listing of content items and can also search the user's personal media profile to generate a second listing of content items. The two listings can be presented, e.g., in separate tabs in a user interface.

The following detailed description together with the accompanying drawings will provide a better understanding of the nature and advantages of the present invention.

### BRIEF DESCRIPTION OF THE DRAWINGS

FIG. 1 shows an example of a media delivery system according to an embodiment of the present invention.

FIG. 2 shows a simplified example of a personal media profile according to an embodiment of the present invention.

FIG. 3 shows an example of an artist page according to an embodiment of the present invention.

FIG. 4 shows another example of an artist page according to an embodiment of the present invention.

FIG. 5 is a flow diagram of a process for generating page data for an artist page according to an embodiment of the present invention.

FIG. 6 is a flow diagram of a process for generating page data for a search results page according to an embodiment of the present invention.

FIG. 7 is a simplified block diagram of a computer system according to an embodiment of the present invention.

### DETAILED DESCRIPTION

For purposes of illustration, the following description and drawings may include names of actual artists (individuals and/or bands), songs, and albums, as well as various images (including artwork) that may be proprietary to artists or other third parties. It is to be understood that use of such names and images herein is solely for purposes of illustrating the creation and presentation of media content interfaces within the context of this application, and use of such names and images herein is not intended to imply any claim of ownership by the inventors or assignee of this application as to any of the names, images, or other content. It is further to be understood that use of such names and images does not imply any endorsement of this application by named artists or other third parties or any other connection between this application and any named artists or other third parties. Any statements herein that may appear to be attributed to an actual artist should be understood as fictional.

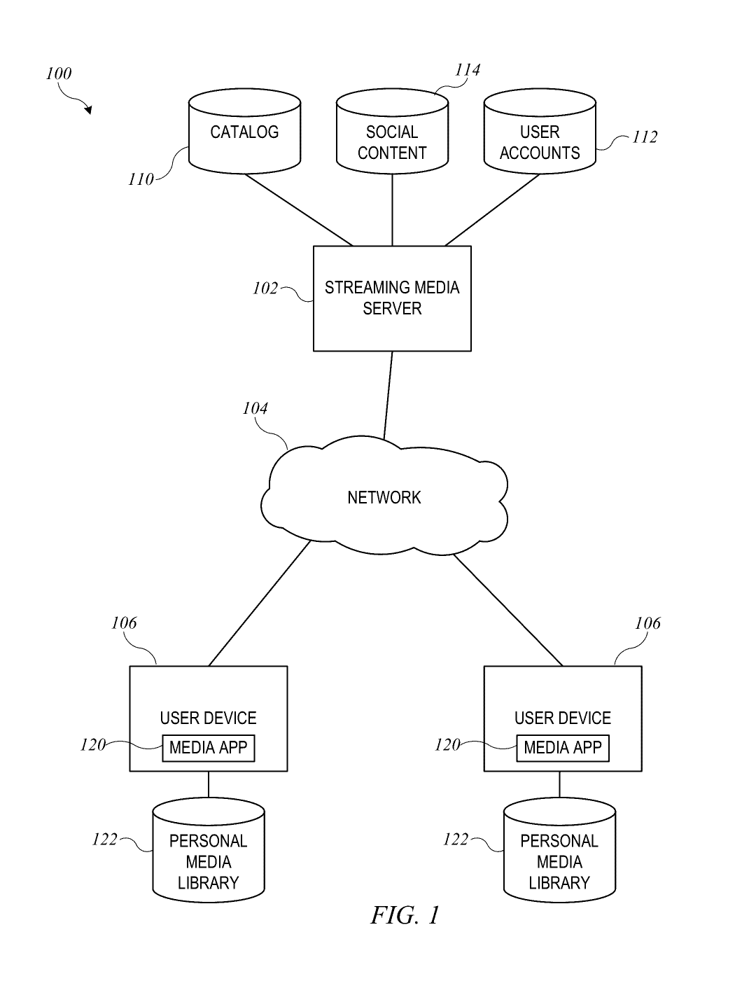

FIG. 1 shows an example of a media delivery system 100 according to an embodiment of the present invention. Media delivery system 100 can include a streaming media server 102 communicably connected to a network 104 (e.g., the Internet). User devices 106 can also connect to network 104 and can connect to server 102 via network 104.

Streaming media server 102 can be implemented as a computer system or an interconnected set of computer systems (e.g., a server farm or multiple server farms, elements of which can be geographically dispersed as desired). Streaming media server 102 can have access to a catalog repository 110, which can store media content items that can be streamed or otherwise delivered to user devices 106. Catalog repository 110 can be implemented using large-scale data storage and retrieval technologies and can include a collection of media content items (which can be stored as computer-readable data files containing a representation of media content) as well as an index to the collection. The index can be, e.g., a database or other structured data store that associates various items of metadata descriptive of each media content item (which can include any data descriptive of the content item or some aspect thereof) with a reference to the location where the content item is stored. The index can be used to facilitate searching and browsing of media content items stored in catalog repository 110. For example, metadata for a media content item can include a track title (e.g., song title, book title, video title), artist information (e.g., name of a band or individual performer that created the content item), album information (e.g., if the media content item is part of an album), track information (e.g., if the media content item incorporates a collection of related content items referred to as “tracks,” such as the individual songs on an album), date of creation, genre information, and so on. A particular storage configuration or indexing scheme is not required.

Streaming media server 104 can also have access to a user account information repository 112, which can store information about user accounts for the streaming media service. User account information repository 112 can be implemented using large-scale data storage and retrieval technologies and can include, e.g., a database of user account records pertaining to accounts established by users with the streaming media service. For example, a user operating one of user devices 106 can communicate with streaming media server 102 to establish an account. Establishing an account can include defining a username and password that can be used to identify and authenticate a particular user. Additional user account information can be collected, e.g., by express user input or automatically based on interactions between user device 106 and streaming media server 102. Examples of user account information can include subscription and payment information (e.g., whether the user is a subscriber and whether applicable subscription fees have been paid), contact information (e.g., email address, phone number, mailing address), demographic information (e.g., age, gender, location, etc.), and so on.

In some embodiments, user account information can also other information, such as listening history, purchase history, a personal media profile (an example of which is described below), information pertaining to the user's interaction with social features of the streaming media service (assuming social features are supported), settings and preferences (e.g., whether to show or suppress explicit content) and so on.

In some embodiments, a streaming media service can support “social” features that can facilitate interactions between various users of the service or between users and artists who create content stored in catalog repository 110. For example, artists may be able to post “uploaded” media content items that are not necessarily included in catalog 110. Social posts and uploaded content items included in social posts can be stored in social content repository 114. Examples of social features, including social posts, are described in above-referenced U.S. Provisional Application No. 62/171,812. In the present context, it is to be understood that social features are optional.

Each user device 106 can belong to a user of a streaming media service operating through streaming media server 102. User device 106 can include various general-purpose user-operable computing devices, such as a smart phone, a tablet computer, a desktop or laptop computer, a wearable computing device, or the like. In some embodiments, the provider of a streaming media service can provide a media application program 120 (also referred to as a “media app”) that, when executed on user device 106, enables user device 106 to interact with streaming media server 102 to browse catalog repository 110, search catalog repository 110, and stream selected media content items from catalog repository 110 to user device 106. Accordingly, media app 120 can provide user account credentials (e.g., username and password) to streaming media server 102, allowing streaming media server 102 to retrieve user account information from user account information storage 112 and to customize the experience for a particular user. It is to be understood that a user can access the same user account on streaming media server 102 using different user devices 106.

Depending on implementation, streaming media server 102 can provide a variety of experiences to user device 106 executing media app 110. For example, media app 120 can present a graphical user interface (“GUI”) that allows a user to search or browse the media content stored in catalog 110. In response to user input received via the GUI, media app 120 can send requests for information to server 102 (e.g., a request to view content by a particular artist as described below). Server 102 can respond by providing “page data,” which can include instructions and/or information items usable by media app 120 to render another GUI image (sometimes referred to as a “page”) responsive to the request. In some embodiments, the page data can include image content, text elements, references to locations where various elements (e.g., images or icons) used to render a page can be retrieved, hyperlinks or other references to data storage locations (e.g., locations in catalog repository 110) that can be accessed (or not) based on further user input, and so on. In some embodiments, page data provided in response to a user request can include multiple listings of content items that can be presented under different tabs on the rendered page; examples are described below. Further, a page or other GUI rendered by media app 120 can include user-operable controls to request and/or control playing of media content items.

In some embodiments, some or all user devices 106 can also have access to a personal media library 122. Each instance of personal media library 122 can be specific to a particular user and can store media content items as digital data files that have been acquired in some manner by that user. For example, personal media library 122 can store any media content items the user has purchased from online or offline sources (including, but not limited to, streaming media server 102), media content items the user has ripped from CDs or other physical storage media, media content items the user has recorded, media content items the user has copied into personal media library 122 from other sources, and so on. Depending on implementation, personal media library 122 can also include media content items the user has temporarily downloaded from streaming media server 102; alternatively, temporarily downloaded media content items can be stored elsewhere on user device 106, in storage that is physically or logically separate from personal media library 122. It should be understood that media content items in personal media library 122 can but need not have been acquired via streaming media server 102 and that any given media content item in personal media library 122 might or might not be present in catalog repository 110. Personal media library 122 can include an index or database or the like that associates various items of metadata descriptive of each media content item (which can include any data descriptive of the content item or some aspect thereof) with a reference to the location in personal media library 122 where the content item is stored. Some instances of personal media library 122 can be implemented in storage that is physically local to a particular user device 106 (e.g., built-in disk or memory), and a user with multiple devices can synchronize instances of personal media library 122 across the devices, e.g., using known synchronization techniques. Some instances of personal media library 122 can be cloud-based, and user device 106 can access cloud-based personal media library 122 via network 104. Personal media library 122 need not be directly accessible to streaming media server 102; in some embodiments, streaming media server 102 can obtain information about the content of personal media library 122 (e.g., metadata included in the index) by communicating with user device 106.

In operation, user device 106 can execute media app 120. Responsive to user input, user device 106 can communicate with streaming media server 102 to identify content to be streamed to user device 106 and to initiate and control streaming of such content. For example, the user can select and play specific content items (e.g., a track or an album).

Depending on implementation, streaming media server 102 may also support other streaming services. For example, the operator of streaming media server 102 may allow certain individuals to act as “curators” who can define playlists of media content items; other users can select a playlist and receive the content items contained therein. As another example, streaming media server 102 can support “radio” stations, which can be ongoing streams of media content that a user can select to experience at any time. In various embodiments, radio stations can include “live” streams (e.g., a digitized version of a terrestrial radio broadcast) and/or algorithmically-generated (and therefore potentially endless) playlists of content items selected by a computer algorithm according to some criterion (e.g., genre, time period, or similarity to a specific “seed” artist selected by a user).

In addition, in some embodiments, streaming media server 102 can provide ancillary services. For instance, a user may be able to bookmark media content items from the catalog. As used herein, “bookmarking” refers generally to a process by which the user provides input indicating that he or she wants to remember a particular content item or make it easy to find that content item again, e.g., through a list of bookmarked items. In some embodiments, when the user bookmarks a media content item, a data record identifying the content item can be added to the user's account information in user account information repository 112. Media app 120 can provide a control operable by the user to access a list of bookmarked content items.

Another ancillary service can be downloading content items for offline listening. In general, it is assumed that streamed content items are not persistently stored on user device 106 (although they may be temporarily stored or buffered during playing of the content). Downloading can allow a content item to be stored for a longer period and to be accessed in situations where user device 106 might not be able to communicate with streaming media server 102 (e.g., when the user is in an airplane or in an area that lacks connectivity to network 104). In various embodiments, downloaded content may be automatically deleted after a specific time (e.g., 24 hours, 48 hours); a user may also be limited as to the number of content items that can be downloaded at any given time and/or how many times a particular downloaded content item can be played.

Another ancillary service can be purchasing content items. When a content item is purchased, user device 106 can indefinitely store a copy of the content item, e.g., in personal media library 122. Purchased content items can be played by user device 106 without restriction.

Another ancillary service can be a social posting service, e.g., as described in above-referenced U.S. Provisional Application No. 62/171,812. A social posting service can allow an artist (or, depending on implementation, any user) to create a post to be stored in social content repository 114. A post can include various types of content, including a reference to catalog content items or a non-catalog content item uploaded by the artist (or post creator) to streaming media server 102 for the purpose of social sharing. Where social posting is supported, user device 106 can present posts or content items from social content repository 114 in connection with rendering various pages; examples are described below.

In some embodiments, streaming media server 102 can restrict access to some or all of its services to users who have paid an access fee (referred to herein as “subscribers”). For example, users who are not subscribers might be permitted to purchase content items but not to bookmark or download content items, and streaming access by non-subscribers can be limited (e.g., a non-subscriber may be permitted to stream only a limited number of content items per month or to stream only a preview portion of any given content item). Additional or different restrictions can also be applied.

It will be appreciated that system 100 is illustrative and that variations and modifications are possible. Any number of user accounts and user devices can be supported. Media content items can include any type of media content (including music, spoken-word, books, video, images, etc.). In some cases, a user may have created multiple personal media libraries, and any or all of these libraries can be accessed in connection with operations described herein.

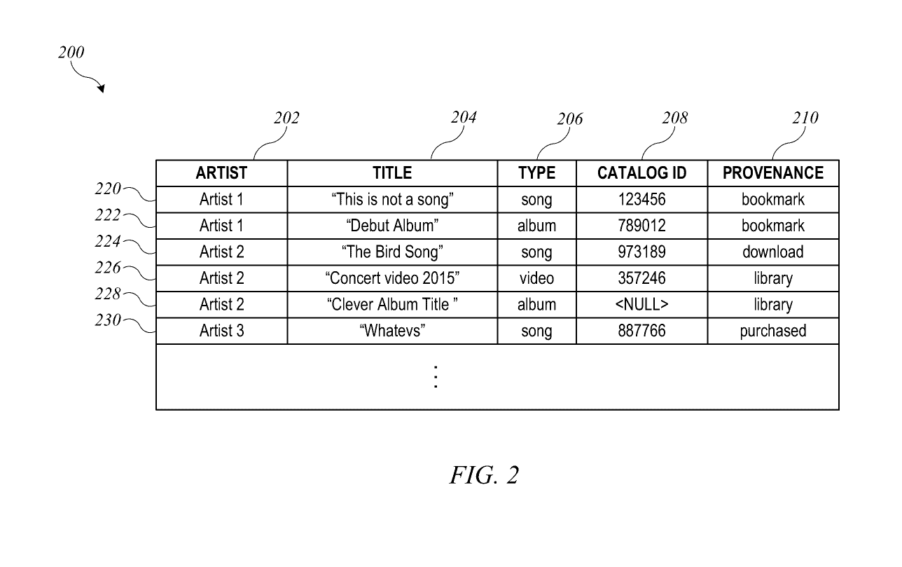

As noted above, a streaming media service can maintain a personal media profile for each user, e.g., in user account information repository 112. As used herein, a “personal media profile” can refer to an index, database, or other listing of media content items with which the user has established some form of persistent association by taking some action with respect to that content item. FIG. 2 shows a simplified example of a personal media profile 200 according to an embodiment of the present invention. Personal media profile 200, represented as a table for purposes of illustration, can be implemented using any data structure capable of collecting information (e.g., metadata) about media content items. In this example, personal media profile 200 has an entry (a row) corresponding to each media content item in a hypothetical user's personal media profile. The information for each content item can include an artist identifier (column 202), a title (column 204), a content type (column 206), a catalog ID (column 208), and a provenance indicator (column 210).

Artist identifier 202 can be any identifier of the artist to whom the content item is attributed (e.g., a band in the case of a song), and title 204 can be the title of the content item. While human-readable labels are shown, it is to be understood that a personal media profile, as stored in a computer system, can use other identifiers. Content type 206 can designate the type of media content item (e.g., song, album, video); the particular set of recognized content types can depend on the media types supported by streaming media server 102.

Catalog ID (identifier) 208 can be a unique identifier of the content item used by catalog repository 110. In some embodiments, catalog ID 208 can be used by streaming media server 102 to facilitate retrieval of additional information about a content item and/or the content item itself.

Provenance 210 can be an indicator of how the content item came to be added to personal music profile 200. The same content item in different users' personal music profiles can have different provenance, as content items can be distributed through multiple channels. As used in table 200, “bookmark” denotes that the user has bookmarked the content item via streaming media server 102; “download” denotes that the user has temporarily downloaded the content item via streaming media server 102; “purchased” denotes that the user has purchased the content item via streaming media server 102; and “library” indicates that streaming media server 102 has identified the content item as being present in the user's personal media library 122. In this example, streaming media server 102 (and/or personal media profile 200) can be agnostic as to how library content came to be in the user's personal media library 122.

In operation, personal media profile 200 can be populated as the user interacts with streaming media server 102. For example, when the user bookmarks a catalog song, entry 220 can be added to represent the song. When the user bookmarks a catalog album, entry 222 can be added to represent the album. When the user downloads a catalog song for later listening, entry 224 can be added to represent the song. In these instances, the user is interacting with catalog content, and streaming media server 102 can obtain metadata to populate columns 202, 204, 206, 208 from catalog repository 110.

Entries 226 and 228 in this example correspond to items in the user's personal media library 122. Accordingly, the content items represented might or might not be present in catalog repository 110. In some embodiments, streaming media server 102 can obtain metadata for items in the user's personal media library 122 from user device 106, then attempt to match the metadata to an item in catalog repository 110. If successful (e.g., as in the case of entry 226), the catalog ID can be populated from catalog repository 110. If unsuccessful (e.g., as in the case of entry 228), the catalog ID can be set to a null value. In other embodiments, streaming media server 102 need not attempt to match items in the user's personal media library to items in catalog repository 110, and the catalog ID for any item in the user's personal media library 122 can have the null value.

Entry 230 in this example corresponds to an item the user purchased via streaming media service 102. As with bookmarked and downloaded items, the user is interacting with catalog content, and streaming media server 102 can obtain metadata to populate columns 202, 204, 206, 208 from catalog repository 110.

In this example, personal media profile 200 is not intended as a comprehensive media-consumption history. Rather than including every content item the user may have consumed (e.g., every content item streamed while listening to a radio station, playlist, selected album, or selected song), personal media profile 200 can selectively include only items that the user has actively indicated a likely interest in locating and/or consuming again in the future. (Populating of personal media profile 220 can be based on an assumption that a user would not make the effort to bookmark an item, download an item, purchase an item, or add an item to a personal media library unless the user had an ongoing interest in the item. It is to be understood that this assumption may not hold in all specific instances, and knowledge of a user's actual intention in taking an action is not required.) In some embodiments, a streaming media service can maintain a media consumption history for a user, which can be separate from personal media profile 200. If desired, the media consumption history can be used to identify content items the user consumes repeatedly; such content items can optionally be added to the user's personal media profile.

Personal media profile 200 can be populated automatically based on user behavior, and personal media profile 200 can be stored and managed by streaming media server 102 as user account information for the user's account. In some embodiments, users may have an option to view and edit their personal media profiles. In some embodiments, portions or all of personal media profile 200 can be stored on user device 106 in addition to or instead of being stored by server 102 in user account information repository 112. In some embodiments, both user device 106 and server 102 can maintain copies of personal media profile 200, and the copies can be synchronized whenever user device 106 connects to server 102.

It will be appreciated that personal media profile 200 is illustrative and that variations and modifications are possible. The amount and combination of metadata included in personal media profile 200 can be varied as desired and can include more or less detail than shown. For example, in the case of a song, the metadata in personal media profile 200 can include an album identifier, a year the song or album was recorded or released, an identifier of an artwork image to be associated with the song or album (which can be used when rendering content listings that include the song, e.g., as described below) and so on. Where the song (or other content item) is resident in catalog 110, metadata can be extracted from catalog 110 and added to personal media profile 200, or a catalog ID reference can be stored in personal media profile 200 and subsequently used to retrieve other metadata when a page listing the song (or other content item) is being generated. Where the song (or other content item) is not resident in catalog 110, metadata for the corresponding entry in personal media profile 200 can be populated using information in personal media library 122. In some embodiments, the information in personal media library 122 may be incomplete; for instance, a year of recording or release, an artwork image, or even a song title or artist name may be missing. Where this is the case, a partially populated entry can be included in personal media profile 200. In some instances, incomplete data may result in certain items not appearing in content listings where they would otherwise be expected, but has no other effect.

According to some embodiments of the present invention, a personal media profile (e.g., profile 200) can be used to customize information presentations for a specific user. An example will now be described. For purposes of this example, it is assumed that user device 106 has made a request to server 102 to present an “artist page,” which can be a graphical user interface image that lists content items by (or otherwise associated with) a specific artist, such as a band or individual performer.

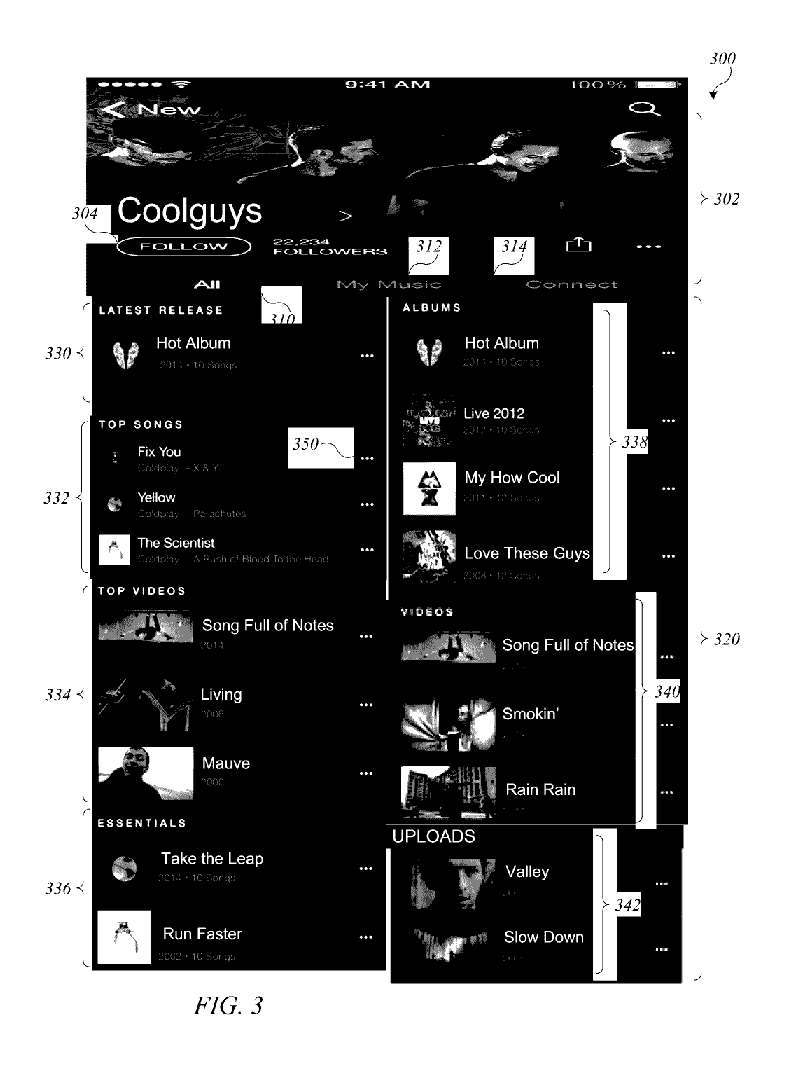

FIG. 3 shows an example of an artist page 300 according to an embodiment of the present invention. Artist page 300 can be rendered, e.g., by music app 120 executing on user device 106. For purposes of description, all graphical user interface images (also referred to as “pages” or “screens”) shown herein (including artist page 300) are assumed to be presented on a touchscreen display, which allows the user to interact with user-operable control elements by tapping on appropriate areas of the display or performing other touch gestures such as swiping to scroll or the like. Other user interfaces can be substituted.

Artist page 300 can include a collection of information about a particular artist whose work is represented in catalog repository 110. In some embodiments, an artist page can be generated algorithmically for any artist (individual or band) to whom is attributed at least one content item in catalog 110. For example, artist page 300 can feature a “band” image 302 for the artist. In some embodiments, an artist (who can be an individual or member of a band) can provide a band image to be used in various user interface screens representing the artist or their work; alternatively, the streaming media service can select a band image for some or all artists. The rest of artist page 300 can have a background color (and text color) that is at least somewhat distinctive to the artist. For example, the background color and text color can be selected algorithmically, using an algorithm that takes the colors of the band image as input and generates an output background and text color. These features can allow artist pages for different artists to have a visually distinct appearance. Band image 302, or a portion thereof, can be overlaid with the artist name 304. In some embodiments, artist name 304 can be an active interface element that the user can select to learn more about the artist. For instance, a user may be able to access a history of the band, description of the band, information about individual band members, and so on. Other options can be provided, such as options to “follow” the artist (and thereby receive social posts and/or other notifications related to the artist, depending on the capabilities of a particular streaming media service).

Artist page 300 can include various user-selectable “tabs” to allow the user to view different subsets of information about the artist. For instance, “All” tab 310 can be selected to view a listing of catalog content items by the artist, and “My Music” tab 312 can be selected to view a listing of content items by the artist that are in the user's personal music profile. In some embodiments, “Connect” tab 314 can be provided to facilitate access to social content created by or pertaining to the artist, e.g., as described in above-referenced U.S. Provisional Application No. 62/171,812.

In the example shown in FIG. 3, “All” tab 310 has been selected, and tab content area 320 displays a listing of catalog content items by the artist. As used herein, a “listing” can include any visual representation of media content items; in the example shown, the listing displays titles, cover art, and other information. A listing can be arranged on a page (or user interface screen) as desired; the two-column format shown in FIG. 3 is optional, and the arrangement can be optimized based on the display area of the device. If the listing is too large to present on a single screen, tab content area 320 (or all of artist page 300) can be scrollable to allow the user to view other portions of the listing. In some embodiments, when “All” tab 310 is selected, tab content area 320 can show all catalog content items by the artist.

In this example, the “All” tab listing shown in tab content area 320 can be organized by content type, and the organization may be based on assumptions about what users in general (or a specific user) are likely to be interested in. For example, the band's most recently released album can be prominently featured at 330. “Top songs” section 332 and “top videos” section 334 can feature a selection of the artist's content based on a popularity metric; various popularity metrics can be used. “Essentials” section 336 can be a curated selection of representative content items for that artist (e.g., songs or albums); the curator can be, e.g., an editorial team employed by the provider of the streaming music service.

“Albums” section 338 can include an entry for each album by the artist that is present in catalog repository 110. In some embodiments, each album entry can be expandable (e.g., by tapping on it) to view a listing of songs included in the album; in other embodiments, tapping on an album entry can result in navigating to an album page that can provide a listing of songs and other information about the album.

“Videos” section 340 can include an entry for each video by the artist that is present in catalog repository 110.

“Uploads” section 342 can include uploaded content items by the artist, which may have been uploaded as part of a social post by the artist, e.g., as described in above-referenced U.S. Provisional Application No. 62/171,812.

It should be understood that the listing in content area 320 can be generated by streaming media server 102 extracting information from catalog 110, without reference to the user's personal media profile 200. In some embodiments, streaming media server 102 can generate page data based on the extracted information and provide the page data to user device 106 for use in rendering an “All” tab view as shown. Thus, catalog items can be listed in the “All” tab view irrespective of whether the corresponding item is or is not present in the user's personal media profile. The particular arrangement and groupings of catalog items shown are illustrative and can be modified as desired.

In the example shown, each entry in the listing in content area 320 includes an options control 350 (represented as three dots). Selecting options control 350 for a particular entry can bring up a menu of options for interacting with the corresponding content item. For instance, the user may be able to begin playing the content item, bookmark the content item, download the content item, and/or purchase the content item. In some embodiments, the available options may depend on whether the user has previously taken any of these actions with respect to the content item. For instance, if the user has bookmarked the content item, the menu can so indicate and offer the user an option to remove the bookmark. If the user has already purchased the content item, the menu can so indicate (e.g., by disabling an option to purchase the item, by displaying an alternative indicator such as “purchased” instead of a purchase price, etc.). If the user takes any actions with respect to a listed content item, the user's personal media profile 200 can be updated accordingly.

If the user chooses to play an item from the “All” tab view, user device 106 can initiate streaming of the content item from streaming media server 102. In some embodiments, in response to a user request to play an item, user device 106 can first determine whether the item happens to be locally stored (e.g., in personal media library 122 or in a storage area used to store temporarily downloaded content items from the streaming media service). If so, then user device 106 can play the item from the local storage; if not, then user device 106 can initiate streaming from streaming media server 102. Using local storage as a preferred content source when available can reduce the user's consumption of network bandwidth.

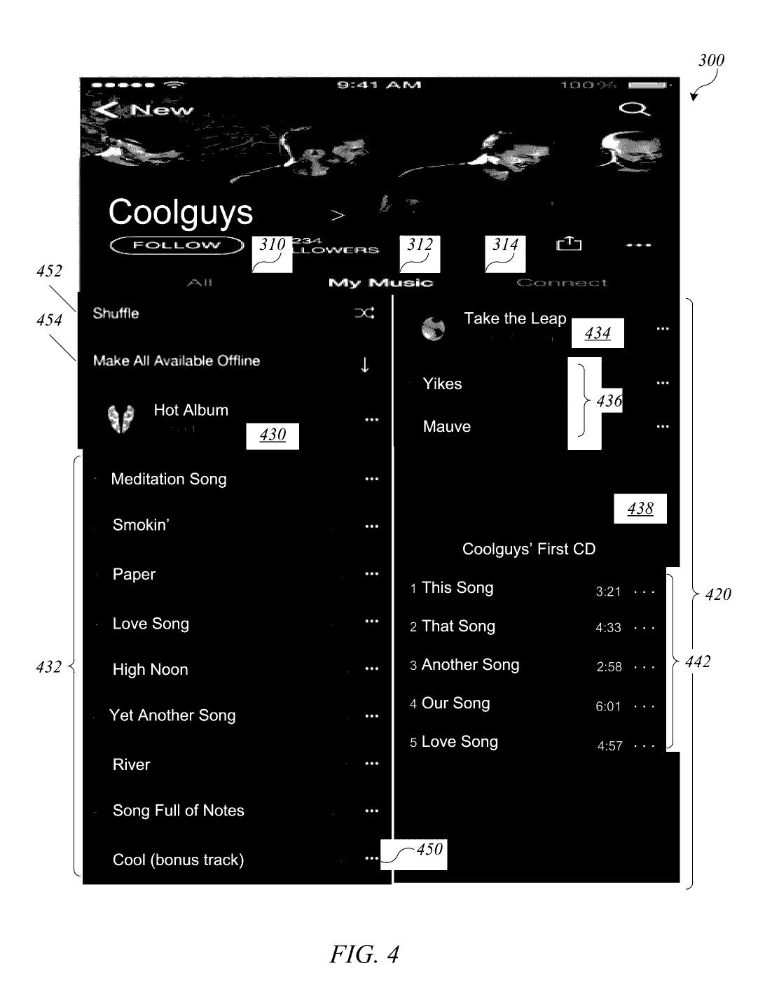

In addition to “All” tab 310, artist page 300 can include “My Music” tab (or more generally a “My Media” tab) 312. FIG. 4 shows an example of artist page 300 with “My Music” tab 312 selected. The top portion of page 300 (above tabs 310, 312, 314) can be as described above with reference to FIG. 3. In this case, responsive to user selection of “My Music” tab 312, content area 420 can provide a different listing. Specifically the listing of content items in area 420 can include content items that are in the user's personal music profile 200 and attributed to the artist whose artist page is being rendered. The listing in content area 420 can be generated, e.g., by streaming media server 102 (or music app 120) extracting information from the user's personal media profile 200. In some embodiments, streaming media server 102 can generate page data based on the extracted information and provide the page data to user device 106 for use in rendering a “My Music” tab view as shown. Thus, any item in the user's personal media profile 200 can be listed in the “My Music” tab view irrespective of whether the corresponding item is or is not present in catalog repository 110.

The arrangement of the listing in content area 420 can be varied as desired. In this example, entries are grouped by album, and under each album is a track list showing the songs (or “tracks”) from the album that are in the user's personal media profile. For example, in the case of album 430 (“Hot Album”), all tracks are shown in track list 432. This can signify that the user has purchased, bookmarked, and/or downloaded all songs on the album. For instance, if the user purchases an album, all songs from the album can be automatically included in the user's personal media profile 200. In the case of album 434 (“Take the Leap”), only two tracks are shown in track list 436, signifying that the user has only purchased, bookmarked, and/or downloaded these two songs.

Album 438 is an example of an album that is not present in catalog repository 110. The user in this example has obtained album 438 from some other source (e.g., ripping a CD), added it to personal media library 122, and identified it as being by the artist “Coolguys.” Since album 438 is not in the catalog, streaming media server 102 does not have artwork for album 438, and accordingly cover-art image 440 can show a default image. In some embodiments, a user may be able to load cover art for an album into personal media library 122; where this is the case, such cover art can be included in the rendering of a content listing in content area 420 or elsewhere. The album title, song titles shown in track list 442, and any other information presented can be extracted from the user's personal media profile 200 or directly from personal media library 122. Any information that is missing can be populated with a default value. For instance, if the user did not enter song titles for a ripped CD, default titles such as “Track 1,”. “Track 2,” etc. can be shown.

In the example shown, each entry in the listing in content area 420 includes an options control 450 (represented as three dots). Similarly to options control 350 described above, touching options control 450 for a particular entry can bring up a menu of options for interacting with the corresponding content item. For instance, the user may be able to begin playing the content item, bookmark the content item, download the content item, and/or purchase the content item. In some embodiments, the available options may depend on which action(s) the user has previously taken with respect to the content item. For instance, if the user has bookmarked the content item, the menu can so indicate and offer the user an option to remove the bookmark. If the user has already purchased the content item, the menu can so indicate (e.g., by disabling an option to purchase the item, by displaying an alternative indicator such as “purchased” instead of a purchase price, etc.). If the user takes any of these actions with respect to a listed content item, the user's personal media profile 200 can be updated accordingly.

Options control 450 can also be presented for non-catalog content items, such as album 440 and songs in track listing 442. For non-catalog content items, options that pertain only to catalog items (e.g., bookmarking, downloading, and/or purchasing) need not be presented.

Content area 420 can also include other options for interacting with the listed content item. For example, “Shuffle” control element 452 can allow the user to shuffle all of the content items listed in content area 420 and begin playing them. “Make all available offline” control element 454 can allow the user to download all of the content items listed in content area 420 for offline listening. In some instances, some of the items may already be downloaded (or persistently stored in the user's personal media library 122). Where this is the case, user device 106 can determine which items are not already locally present and can communicate with streaming media server 102 to download those items. Thus, the user is spared the effort of figuring out which items are or are not locally present.

If the user chooses to play an item from the “My Music” tab view, user device 106 can initiate streaming of the content item from streaming media server 102 or (for non-catalog content) playing of the content item from the user's personal media library 122. In some embodiments, in response to a user request to play an item, user device 106 can first determine whether the item happens to be locally stored (e.g., in personal media library 122 or in a storage area used to store temporarily downloaded content items from the streaming media service). If so, then user device 106 can play the item from the local storage; if not, then user device 106 can initiate streaming from streaming media server 102. Using local storage as a preferred content source when available can reduce the user's consumption of network bandwidth.

In the examples shown, items listed under “All” tab 310 are not visually distinguished based on where they are located or whether they are present in the user's personal media profile 200. Similarly, items listed under “My Music” tab 312 are not visually distinguished based on how they came to be in the user's personal media profile 200 or whether they are also in catalog repository 110. This can allow the user to view and interact with content items without concern for their source or current location, thus providing the user a more holistic view of media content items that are available for consumption and/or media content items that the user has indicated specific interest in.

It will be appreciated that artist page 300 is illustrative and that variations and modifications are possible. Listings of content items can be arranged as desired, and aesthetic elements can be varied. For instance, sections of the listing may be expandable or collapsible. In some embodiments, “My Music” tab 312 is made visible only in instances where there is at least one content item to be listed under that tab. This can spare the user from selecting a tab only to find that the listing is empty. Thus, for instance, if a particular user's personal media profile does not include any content items by “Coolguys,” the rendering of page 300 for that user might include just “All” tab 310 and “Connect” tab 314.

In some embodiments, the content listing under “All” tab 310 can be the same for all users, since this is a listing of catalog items irrespective of what is present in a particular user's personal media profile. The content listing under “My Music” tab 312 can be user-specific, since this is a listing of items in the user's personal media profile, irrespective of what is present in the catalog.

In some embodiments, the content listing under “My Music” tab 312 can be dynamic. For example, if the user viewing “All” tab 310 bookmarks a song or album from content listing 320, then the next time the user views “My Music” tab 312, that song or album can appear in content listing area 420.

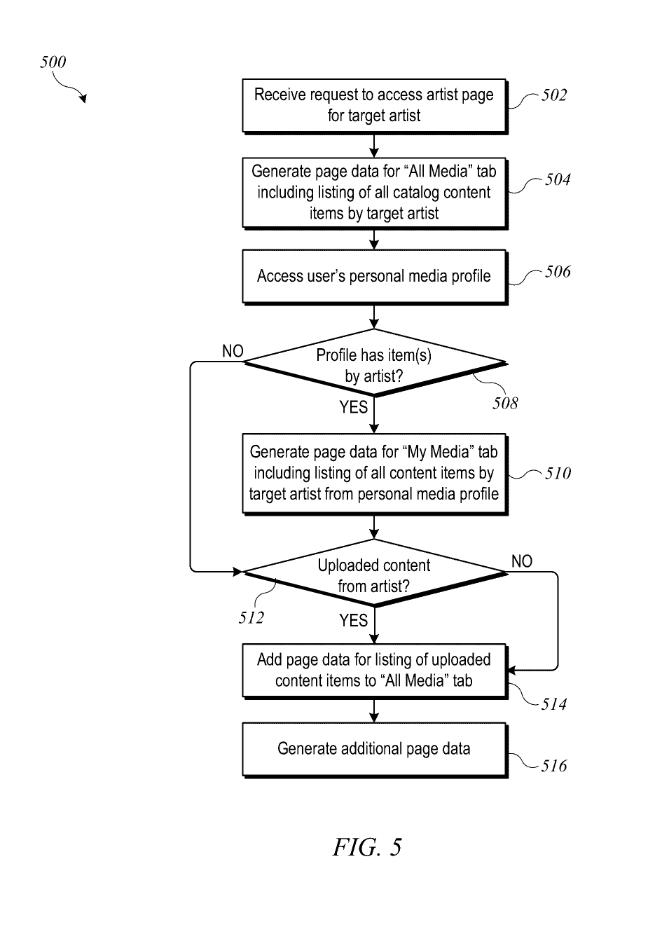

FIG. 5 is a flow diagram of a process 500 for generating page data for an artist page (e.g., artist page 300 of FIGS. 3 and 4) according to an embodiment of the present invention. Process 500 can be implemented, e.g., in streaming media server 102 of FIG. 1 and/or in user device 106 interacting with streaming media server 102.

Process 500 can begin at block 502, when a request is received to access an artist page for a specific (“target”) artist; the target artist can be identified in the request.

At block 504, process 500 can generate page data for an “All Media” tab of the artist page; the page data can include a listing of catalog content items by the target artist. For example, process 500 can query catalog repository 110 using the target artist identifier to obtain metadata for each catalog content item by the target artist. Based on the obtained metadata, process 500 can generate instructions or information for rendering a listing of the catalog content items. These instructions or information can be included in the page data for the “All Media” tab of the artist page. In some embodiments, all catalog content items by the target artist can be represented in the listing.

At block 506, process 500 can access the user's personal media profile (e.g., personal media profile 200), and at block 508, process 500 can determine whether the personal media profile includes any content items by the target artist. If so, then at block 510, process 500 can generate page data for a “My Media” tab of the artist page; the page data can include a listing of content items by the target artist that are in the user's personal media profile. In various embodiments, process 500 can obtain metadata for the listing from personal media profile 200 and/or catalog 110 (e.g., as described above). Based on the obtained metadata, process 500 can generate instructions or information for rendering a listing of the content items from the user's personal media profile. These instructions or information can be included in the page data for the “My Media” tab of the artist page. In some embodiments, all content items in the user's personal media profile by the target artist can be represented in the listing.

In some embodiments, the “All Media” tab of an artist page can include uploaded content from the artist, e.g., as described above with reference to FIG. 3. Accordingly, at block 512, process 500 can determine whether uploaded content is available for the artist, e.g., by querying social content repository 114. If so, then at block 514, process 500 can add page data for a listing of uploaded content items to the “All Media” tab of the artist page, e.g., using metadata obtained from social content repository 114. In some embodiments, process 500 can also include other operations based on querying social content repository 114, e.g., generating a “Connect” tab that can be used to present social posts or other content by the artist.

At block 516, process 500 can generate additional page data for the artist page. For example, process 500 can identify a band image for the artist page, determine a color scheme for the page (e.g., based on the band image), define additional control elements to be included on the page, and so on.

Page data generated using process 500 can be rendered on a user device, e.g., user device 106. For example, in some embodiments, user device 106 can initiate process 500 by sending a request for an artist page to streaming media server 102, and streaming media server 102 can execute process 500 to generate page data, then transmit the page data to user device 106. User device 106 can render an artist page (e.g., artist page 300) based on the received page data. In other embodiments, at least some portions of process 500 may be performed by user device 106. For example, if user device 106 has a stored copy of personal media profile 200, user device 106 can perform at least blocks 506 and 508 of process 500 and may be able to perform other operations as well. In some embodiments, user device 106 can query server 102 to obtain metadata for catalog content items (at block 504) and can generate the listing itself based on the query response. Other divisions of operations within process 500 are also possible.

The examples described above refer to an artist page, where content items are included in or excluded from a listing based on the artist identifier. It is to be understood that similar ownership-agnostic views can be generated for any other type of content listing that a user may request. For example, a user may search for content by title, by genre, by year (or time period) of release, by content type, or by any other criterion or combination of criteria. Any search result can be presented in a format similar to artist page 300. For example, the top of the page can indicate the selection criteria (e.g., the search query provided by the user), and a set of tabs can be presented to allow the user to view either a listing of all catalog items that satisfy the selection criteria (similar to “All” tab 310 described above) or a listing of all items in the user's personal media profile that satisfy the selection criteria (similar to “My Media” tab 312 described above).

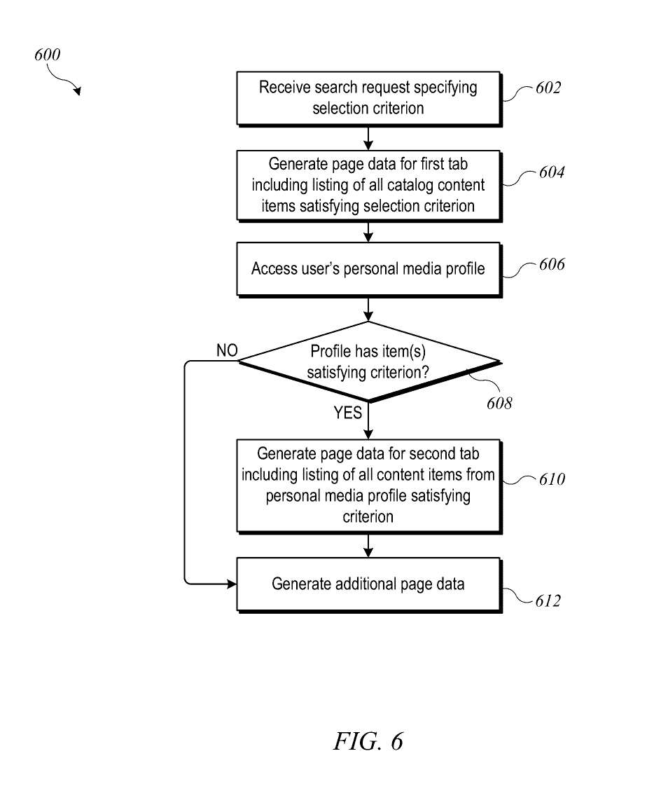

FIG. 6 is a flow diagram of a process 600 for generating page data for a search results page according to an embodiment of the present invention. Process 600 can be implemented, e.g., in streaming media server 102 of FIG. 1 and/or in user device 106 interacting with streaming media server 102.

Process 600 can begin at block 602, when a search request is received. The search request can specify a selection criterion (or multiple selection criteria), such as a search query.

At block 604, process 600 can generate page data for a first tab of a search results page (e.g., an “All” tab); the page data can include a listing of catalog content items that satisfy the selection criterion (or criteria). For example, process 600 can query catalog repository 110 using the search query to obtain metadata for each catalog content item that satisfies the query. Based on the obtained metadata, process 600 can generate instructions or information for rendering a listing of the catalog content items that satisfy the query. These instructions or information can be included in the page data for a first tab of the search results page. In some embodiments, all catalog content items that satisfy the selection criteria can be represented in the listing.

At block 606, process 600 can access the user's personal media profile (e.g., personal media profile 200), and at block 608, process 600 can determine whether the personal media profile includes any content items that satisfy the selection criterion (or criteria). If so, then at block 610, process 600 can generate page data for a second tab of a search results page (e.g., a “My Media” tab); the page data can include a listing of content items in the user's personal media profile that satisfy the selection criterion (or criteria). In various embodiments, process 600 can obtain metadata for the listing from personal media profile 200 and/or catalog 110 (e.g., as described above). Based on the obtained metadata, process 600 can generate instructions or information for rendering a listing of the content items from the user's personal media profile that satisfy the selection criterion (or criteria). These instructions or information can be included in the page data for a second tab of the search results page. In some embodiments, all content items in the user's personal media profile that satisfy the section criteria can be represented in the listing.

At block 612, process 600 can generate additional page data for the search results page. For example, process 600 can determine a color scheme for the page (or use a default color scheme), generate a page banner, define additional control elements to be included on the page, and so on. In some embodiments that support social content, process 600 can also search the social content and generate page data for an additional tab based on the search results.

Page data generated using process 600 can be rendered on a user device, e.g., user device 106. For example, in some embodiments, user device 106 can initiate process 600 by sending a request for an artist page to streaming media server 102, and streaming media server 102 can execute process 600 to generate page data, then transmit the page data to user device 106. User device 106 can render a search-results page (which can be similar to artist page 300) based on the received page data. In other embodiments, at least some portions of process 600 may be performed by user device 106. For example, if user device 106 has a stored copy of personal media profile 200, user device 106 can perform at least blocks 606 and 608 of process 600 and may be able to perform other operations as well. In some embodiments, user device 106 can query server 102 to obtain metadata for catalog content items (at block 604) and can generate the listing itself based on the query response. Other divisions of operations within process 600 are also possible.

In some embodiments, owner-agnostic media content presentations can be limited to subscribers. A non-subscriber may be able to view listings of catalog content (e.g., “All” tab 310 view as shown in FIG. 3) but might not have a personal media profile from which a “My Media” tab can be generated. In other embodiments, a non-subscriber can have a personal media profile; however, if subscribers are not permitted to bookmark or download content items, the non-subscriber's personal media profile may include only purchased items and/or library items as described above. In embodiments that support social posting, access by non-subscribers to social posts and/or uploaded content items can be restricted. For instance, in “All” tab 310 view shown in FIG. 3, uploads listing 342 might not be presented to a non-subscriber. Further, in some embodiments, streaming access by non-subscribers can be limited (e.g., a non-subscriber may be permitted to stream only a limited number of content items per month or to stream only a preview portion of any given content item). Additional or different restrictions can also be applied.

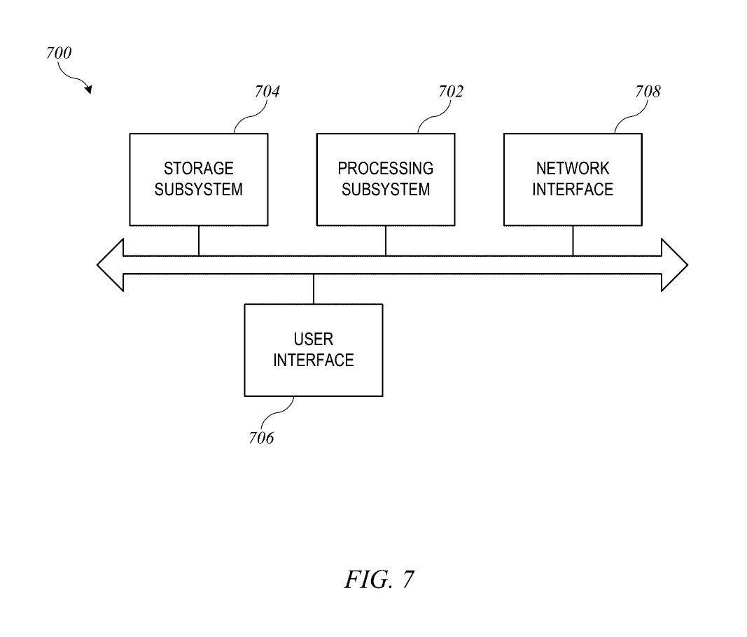

FIG. 7 is a simplified block diagram of a computer system 700 according to an embodiment of the present invention. In some embodiments, computer system 700 can implement any or all of the functions, behaviors, and capabilities described herein as being performed by a user device (including user devices 106 of FIG. 1), as well as other functions, behaviors, and capabilities not expressly described. In some embodiments, another physical instance of computer system 700 can implement any or all of the functions, behaviors, and capabilities described herein as being performed by a server (including streaming media server 102 of FIG. 1).

Computer system 700 can include processing subsystem 702, storage subsystem 704, user interface 706, and network interface 708. Computer system 700 can also include other components (not explicitly shown) such as a battery, power controllers, and other components operable to provide various enhanced capabilities. In some embodiments, computer system 700 can be implemented in a consumer electronic device such as a desktop or laptop computer, tablet computer, smart phone, other mobile phone, wearable device, media device. household appliance, or the like. Computer system 700 can also be implemented in a large-scale architecture such as a scalable server system or server farm that can include many interconnected processors, storage systems and interfaces, capable of processing and responding to high volumes of requests from client devices (including user devices and/or artist devices).

Storage subsystem 704 can be implemented, e.g., using disk, flash memory, or any other non-transitory storage medium, or a combination of media, and can include volatile and/or non-volatile storage media. In some embodiments, storage subsystem 704 can store one or more application and/or operating system programs to be executed by processing subsystem 702, including programs to implement any or all operations described herein as being performed by a user device. For example, storage subsystem 704 can store media app 120 of FIG. 1 and associated data (e.g., personal media library 122). In instances where computer system 700 implements a server, storage subsystem 704 can be implemented using network storage technologies and/or other technologies that can manage high-volume requests to large data stores. For example, storage subsystem 704 can store and manage catalog repository 110, user account information repository 112, and social content repository 114. Depending on implementation, the various repositories can be physically or logically distinct.

User interface 706 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). In some embodiments, a user can operate input devices of user interface 706 to invoke the functionality of computer system 700 and can view and/or hear output from computer system 700 via output devices of user interface 706. For example, all of the user interface screens described above can be rendered on a touchscreen display, and the user can provide input by touching appropriate areas of the touchscreen. Graphical user interfaces can also be rendered using a display screen and a pointing device (e.g., a mouse) that allows the user to control the position of an on-screen cursor; the user can position the cursor and press a button or tap a touch-sensitive surface to make a selection. In instances where computer system 700 implements a server, user interface 706 can be remotely located with respect to processing subsystem 702 and/or storage subsystem 704.

Processing subsystem 702 can be implemented using one or more integrated circuits, e.g., one or more single-core or multi-core microprocessors or microcontrollers, examples of which are known in the art. In operation, processing subsystem 702 can control the operation of computer system 700. In various embodiments, processing subsystem 702 can execute a variety of programs in response to program code and can maintain multiple concurrently executing programs or processes. At any given time, some or all of the program code to be executed can be resident in processing subsystem 702 and/or in storage media such as storage subsystem 704.

Through suitable programming, processing subsystem 702 can provide various functionality for computer system 700. For example, where computer system 700 implements user device 106, processing subsystem 702 can implement various processes (or portions thereof) described above as being implemented by a user device. Processing subsystem 702 can also execute other programs to control other functions of computer system 700, including programs that may be stored in storage subsystem 704. Where computer system 700 implements streaming media server 102, processing subsystem 702 can implement operations including streaming of content, generating page data for rendering various pages (including content listings as described above), performing searches within catalog repository 110 and/or social content repository 114 in response to received requests, and so on.

Network communication interface 708 can provide voice and/or data communication capability for computer system 700. In some embodiments, network communication interface 708 can include radio frequency (RF) transceiver components for accessing wireless data networks (e.g., using data network technology such as 3G, 4G/LTE, IEEE 802.11 family standards (e.g., Wi-Fi network technology), or other mobile communication technologies, or any combination thereof), components for short-range wireless communication (e.g., using Bluetooth and/or Bluetooth LE standards, NFC, etc.), and/or other components. In some embodiments, network communication interface 708 can provide wired network connectivity (e.g., Ethernet) in addition to or instead of a wireless interface. Network communication interface 708 can be implemented using a combination of hardware (e.g., driver circuits, antennas, modulators/demodulators, encoders/decoders, and other analog and/or digital signal processing circuits) and software components. In some embodiments, network communication interface 708 can support multiple communication channels concurrently, using the same transport or different transports.

It will be appreciated that computer system 700 is illustrative and that variations and modifications are possible. User devices implemented using computer system 700 can be portable or non-portable as desired, and any number of user devices can communicate with a streaming media server. User devices and/or streaming media servers can have functionality not described herein (e.g., a user device may provide voice communication via cellular telephone networks; control mechanisms and/or interfaces for operating an appliance such as a thermostat or door lock; ability to interact with the user to provide personal information, play games, access content via the wireless network and/or locally stored content; etc.), and implementations of these devices and servers can include components appropriate to such functionality.

Further, while a computer system is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

While the invention has been described with respect to specific embodiments, one skilled in the art will recognize that numerous modifications are possible. For instance, many of the examples in the foregoing description refer to streaming of music. It is to be understood that ownership-agnostic interfaces can also be presented in conjunction with other types of media delivery services, such as services that provide access to movies, TV programs, games, books, and any other form of media content. In any instance where the user can download, purchase, bookmark, store, or otherwise express an interest in a specific content item, a personal media profile can be generated to identify such content items and facilitate ownership-agnostic presentations of search results, e.g., using different tabs on a search results page as described above.

Various features described herein, e.g., methods, apparatus, computer-readable media and the like, can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features described herein may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method executed at a server of a media streaming service that maintains a catalog of media content items, the method comprising:
receiving, at the server, a request from a user device of a user to view a selection of content items, the request further specifying a selection criterion;
accessing, by the server, a personal media profile of the user, the personal media profile identifying one or more media content items that the user has bookmarked from the catalog, downloaded from the catalog, purchased through the service, or stored in a personal media library of the user device;
generating a first content tab for a page of selected content items, the first content tab including a listing of content items that are present in the catalog and that satisfy the selection criterion, irrespective of whether the content items are or are not present in the personal media profile;
generating a second content tab for the page of selected content items, the second content tab including a listing of all content items that are identified in the personal media profile of the user and that satisfy the selection criterion, irrespective of whether the content items are or are not present in the catalog; and
transmitting, to the user device, the page of selected content items including the first content tab and the second content tab.

2. The method of claim 1 wherein the catalog of media content items includes media content items by a plurality of artists and the selection criterion corresponds to an artist identifier for one of the plurality of artists.

3. The method of claim 2 wherein the media streaming service also maintains a store of posts by the plurality of artists, the method further comprising:
generating a third content tab for the page of selected content items, the third content tab including a post from the store of posts that is by the selected artist.

4. The method of claim 3 wherein the store of posts includes at least one post by the selected artist that includes a non-catalog content item uploaded by the selected artist, the method further comprising:
including, in the first content tab, a listing of the non-catalog content item uploaded by the selected artist.

5. A server system comprising:
a catalog data store to store a catalog of media content items;
a user account data store to store user account information for a plurality of users, the user account information for each user including a personal media profile of the user, the personal media profile identifying media content items that the user has bookmarked from the catalog, downloaded from the catalog, purchased through the service, or stored in a personal media library of the user device;
a network interface; and
a processing subsystem coupled to the user account data store, the catalog data store, the social content data store, and the network interface, the processing subsystem being configured to:
receive, via the network interface, a request from a user device of a user to view a selection of content items, the request further specifying a selection criterion;
access a personal media profile of the user, the personal media profile identifying one or more media content items that the user has bookmarked from the catalog, downloaded from the catalog, purchased through the service, or stored in a personal media library of the user device;
generate a first content tab for a page of selected content items, the first content tab including a listing of content items that are present in the catalog and that satisfy the selection criterion, irrespective of whether the content items are or are not present in the personal media profile;
generate a second content tab for the page of selected content items, the second content tab including a listing of all content items that are identified in the personal media profile of the user and that satisfy the selection criterion, irrespective of whether the content items are or are not present in the catalog; and
transmit, to the user device, the page of selected content items including the first content tab and the second content tab.

6. The server system of claim 5 wherein the catalog of media content items includes media content items by a plurality of artists and the selection criterion corresponds to an artist identifier for one of the plurality of artists.

7. The server system of claim 6 wherein the media streaming service also maintains a store of posts by the plurality of artists, the method further comprising:
generating a third content tab for the artist page, the third content tab including a post from the store of posts that is by the selected artist.

8. The server system of claim 7 wherein the store of posts includes at least one post by the selected artist that includes a non-catalog content item uploaded by the selected artist, the method further comprising:
including, in the first content tab, a listing of the non-catalog content item uploaded by the selected artist.

9. A graphical user interface for interacting with media content, the graphical user interface comprising:
a plurality of content tabs, each content tab including a listing of content items that satisfy a selection criterion,
the plurality of content tabs including:
a first content tab that provides a listing of content items that are present in a catalog of a media streaming service and that satisfy the selection criterion, irrespective of whether the content items are or are not present in a personal media profile of the user, wherein the personal media profile identifies one or more media content items that the user has bookmarked from the catalog, downloaded from the catalog, purchased through the service, or stored in a personal media library of the user device; and
a second content tab including a listing of all content items identified in the personal media profile of the user that are relevant to the request, irrespective of whether the content items are or are not present in the catalog.

10. The graphical user interface of claim 9 wherein the catalog includes media content items by a plurality of artists and the selection criterion corresponds to an artist identifier for a selected artist of the plurality of artists.

11. The graphical user interface of claim 10 wherein the media streaming service also maintains a store of posts by the plurality of artists and wherein the plurality of content tabs further includes:
a third content tab including a post a post from the store of posts that is by the selected artist.

12. The graphical user interface of claim 10 wherein the media streaming service also maintains a store of posts by the plurality of artists, wherein the store of posts includes a first post by the selected artist, wherein the first post includes a non-catalog content item uploaded by the selected artist,
wherein the first content tab includes a listing of the non-catalog content item uploaded by the selected one artist.

13. A method executed at a user device, the method comprising:
receiving, via a user interface of the user device, a user request to view a selection of content items, the user request further specifying a selection criterion, wherein the user has a personal media profile;
obtaining, by the user device, page data for a first content tab of a search results page responsive to the user request, the page data for the first content tab including a listing of content items that satisfy the selection criterion and are present in a catalog of media content items maintained by a streaming media service, irrespective of whether the content items are or are not present in a personal media profile;
accessing, by the user device, the personal media profile of the user, wherein the personal media profile identifies one or more media content items that the user has bookmarked from the catalog, downloaded from the catalog, purchased through the service, or stored in a personal media library;
generating page data for a second content tab of the search results page, the page data for the second content tab including a listing of all content items that are identified in the personal media profile of the user and that satisfy the selection criterion, irrespective of whether the content items are or are not present in the catalog; and
rendering the search results page based at least in part on the page data for one or both of the first and second content tabs.

14. The method of claim 13 wherein obtaining the page data for the first content tab includes:
transmitting the user request to a server of the streaming media service; and
receiving the page data for the first content tab in response to the transmitted user request.

15. The method of claim 13 wherein obtaining the page data for the first content tab includes:
sending, from the user device to a server of the streaming media service, a search query based on the selection criterion;
receiving, by the user device from the server, the listing of content items that satisfy the selection criterion and are present in the catalog of media content items; and
generating, by the user device, the page data for the first content tab based at least in part on the listing of content items received from the server.

16. The method of claim 13 wherein the catalog of media content items includes media content items by a plurality of artists and the selection criterion corresponds to an artist identifier for one of the plurality of artists.

17. A computer system comprising:
a user interface;
a storage device configured to store a personal media profile for a user, wherein the personal media profile identifies one or more media content items that the user has bookmarked from the catalog, downloaded from the catalog, purchased through the service, or stored in a personal media library;
a network interface; and
a processing subsystem coupled to the user interface, the storage device and the network interface, the processing subsystem being configured to:
receive, via the user interface, a user request to view a selection of content items, the user request further specifying a selection criterion;
obtain page data for a first content tab of a search results page responsive to the user request, the page data for the first content tab including a listing of content items that satisfy the selection criterion and are present in a catalog of media content items maintained by a streaming media service, irrespective of whether the content items are or are not present in a personal media profile;
access the personal media profile of the user;
generate page data for a second content tab of the search results page, the page data for the second content tab including a listing of all content items that are identified in the personal media profile of the user and that satisfy the selection criterion, irrespective of whether the content items are or are not present in the catalog; and
render, at the user interface, the search results page based at least in part on the page data for one or both of the first and second content tabs.

18. The computer system of claim 17 wherein the processing subsystem is further configured such that obtaining the page data for the first content tab includes:
transmitting the user request to a server of the streaming media service; and
receiving the page data for the first content tab in response to the transmitted user request.

19. The computer system of claim 17 wherein the media streaming service also maintains a store of posts by the plurality of artists, wherein the selection criterion corresponds to an artist identifier of a selected artist from the plurality of artists, and wherein the page data for the first content tab includes a non-catalog content item uploaded by the selected artist as a post.

20. The computer system of claim 17 wherein the media streaming service also maintains a store of posts by the plurality of artists, wherein the selection criterion corresponds to an artist identifier of a selected artist from the plurality of artists, and wherein the processing subsystem is further configured to obtain page data for a third content tab of the search results page, the third content tab including a post from the store of posts that is by the selected artist.
